(19) United States
(12) Patent Application Publication
(10) Pub. No.: US 2012/0173128 A1
(43) Pub. Date: Jul. 5, 2012

(54) System and Method for Preventing the Operation of a Motor Vehicle Without Required Insurance

(76) Inventor: Theresa Peeler, Canton, IL (US)

(21) Appl. No.: 13/326,510

(22) Filed: Dec. 15, 2011

Related U.S. Application Data
(60) Provisional application No. 61/428,225, filed on Dec. 30, 2010.

(51) Int. Cl. G06F 19/00

(52) U.S. Cl. 701/113

(57) ABSTRACT

A system and method for preventing a motor vehicle from being operated without required insurance is disclosed. The system comprises a vehicle-mounted device interlocked to the ignition, a driver, and insurance carrier, a policy, a credential, a wireless data network and a data service. The vehicle-mounted device accepts a credential issued by the insurance company to identify the insurance policy, driver, and vehicle. The device transmits the credential to the data service for evaluation on the current validity of the insurance and sends a response back to the vehicle-mounted device. The vehicle-mounted device selectively allows or disallows the vehicle to start, depending on whether required insurance is present.

### CROSS-REFERENCE TO RELATED APPLICATIONS

This application claims priority from Provisional Patent Application Ser. No. 61/428,225 filed on Dec. 30, 2010, which is hereby incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to the field of motor vehicle safety systems, and specifically to systems that limit the function of motor vehicles to prohibit violation of motor vehicle safety regulations. Still more specifically, the invention relates to systems that verify that a vehicle carries at least the minimum level of liability insurance required by local law.

The high cost of motor vehicle accidents, whether for human injury or damage to property, is a problem as old as motor vehicles. When an uninsured driver causes a traffic accident, the cost of the accident is born unfairly by the accident victim or the victim's insurance carrier. Many jurisdictions have attempted to address the problem by requiring motor vehicle operators to carry a minimum level of liability insurance for their vehicles as a condition to using public roads. Despite the risk of fines and potential loss of driving privileges for not carrying required insurance, many drivers ignore local requirements and drive without insurance or without adequate insurance.

Many jurisdictions attempt to further enforce insurance requirements by requiring that driver's report their insurance policy information as a condition for required vehicle registration. Even this sort of administrative system may be circumvented because, even though a reported insurance policy may be active at the time of vehicle registration, the same policy may be subsequently canceled, for example for the policy holder not making scheduled payments of the premium.

The prior art discloses numerous systems for reducing the incidence of driving without required insurance. For example, U.S. Pat. No. 5,325,291 to Garret et al. teaches a method by which a state vehicle registration authority may monitor vehicles' insurance status for lapses based on information provided by insurance carriers. Another approach is taught by U.S. Pat. No. 6,233,563 to Jefferson et al., which discloses a system for requiring drivers to prove that they have active insurance as a condition for purchasing gasoline.

U.S. Patent Application Publication No. US 2004/0186749 to Iwuagwu teaches a system by which an individual user may verify the status of a particular insurance policy through a web interface in communication with insurance carrier databases. Similarly, U.S. Patent Application Publication No. US 2006/0138222 to Dearie teaches a system in which an individual, such as a law enforcement officer, may use a scanner device to read insurance information from a barcode decal affixed to the vehicle and verify the status of the vehicles insurance through a data service of the kind disclosed in Dearie.

Additionally, U.S. Patent Application Publication No. US 2011/0057789 to Cai et al. teaches a system by which a mobile device embedded in a vehicle communicates wirelessly with a data service to verify the vehicle's insurance information. The data service taught in Cai responds to a query from an uninsured vehicle by notifying law enforcement of the operation of the uninsured vehicle. Optionally, the Cai data service sends location information for the vehicle to law enforcement, and optionally sending a signal to the embedded device to disable the vehicle.

The Cai system is principally directed at reducing the incidence of uninsured driving through notifying law enforcement of the operation and whereabouts of uninsured vehicles. To the extent that Cai teaches the disablement of uninsured vehicles, it provides only a solution for disabling and safely stopping vehicles that have already been operating on public roads without required insurance. The Cai system, however, does not teach a means for preventing an uninsured vehicle from starting in the first place. Since operating a vehicle without required insurance is generally a crime, the Cai system can only be a crime detection and reporting system, and not a crime prevention system.

An improvement on Cai and other known systems would prevent a vehicle from being operated at all without required insurance. Such a system would be interlocked to the vehicle ignition or other vehicle system necessary for the vehicle to be operated. Ideally, such a system would require the driver to present a credential provided by the insurance carrier, such as a card with a stored electronically readable identifier, or a Personal Identification Number (PIN) to be entered verbally or manually. A vehicle mounted device for such a system would be mounted on the vehicle dash for the driver to operate while starting the vehicle, and the device would be interlocked with the vehicle ignition to selectively allow the vehicle to start or not to start. Since the verification takes place prior to the ignition of the vehicle, it is not necessary for such a system to notify law enforcement of the possible operation of a vehicle without required insurance. Generally, it is not preferable to rely on law enforcement as a first means of ensuring compliance with applicable law when other means are available, since a high frequency of reports can tax scarce law enforcement resources.

Rather, an improved system would enforce insurance requirements effectively with communication only among the system's own components. Such a system would also provide a driver who has been prevented from starting his vehicle an opportunity to discover and correct a lapse of insurance coverage, perhaps due to his carrier's administrative error or his own, without the consequences attendant to having committed the crime of driving without required insurance.

The prior art teaches numerous examples of vehicle ignition interlocks that aim to prevent the driver from starting a vehicle when the driver should not drive. Numerous references teach systems that analyze the driver's breath or skin for the presence of alcohol as a means to prevent drunken driving. Such systems are now commonly required in many jurisdictions as a condition for reinstating driving privileges after a person has been caught driving under the influence of alcohol.

Other references teach systems for disabling a vehicle's ignition to prevent theft and unauthorized use of the vehicle. One example is U.S. Pat. No. 7,088,219 to Dawson et al., which teaches an anti-theft system whereby the vehicle may be disabled based on its electronically determined geographic location or at the remote request of the owner or law enforcement. Ignition interlocks are again exemplified in U.S. Pat. No. 3,359,539 to Fink and U.S. Pat. No. 3,154,167 to Butler teach systems for requiring seatbelt use with an ignition interlock. Additionally, U.S. Patent Application Publication No. US 2011/0178382 to Topp teaches an ignition interlock prevents individuals who suffer from hypoglycemic attacks from driving with insufficient blood glucose.

Universally absent from the art of ignition interlocks are systems that verify the presence of required insurance as a condition for operating the vehicle. A useful and novel system, therefore, would combine an ignition interlock with a mobile device that connects wirelessly to a data service to determine the insurance status of the vehicle sought to be driven. Existing insurance verification systems are generally directed to informing law enforcement of activity by an uninsured vehicle and not to preventing the vehicle from starting and, correspondingly to preventing a crime from being committed. Similarly, existing ignition interlock systems are generally responsive to local inputs, such as the results of an analysis by an on-board chemical sensing device. Those ignition interlock systems that do communicate wirelessly with various data services are primarily concerned with assisting law enforcement in recovering stolen vehicles by disabling vehicles known to be stolen.

### SUMMARY OF THE INVENTION

Accordingly, the following discloses a system and method for preventing a motor vehicle from being driven without adequate insurance. Broadly, the invention combines an ignition interlock with a wireless data system for providing information on the vehicle's current insurance status, according to which operation of the vehicle may be selectively allowed or disallowed.

In the disclosed system and method, insurance carriers issue each covered driver an insurance policy and a credential for use with the system. The insurance carriers provide up to date data on active policies and credentials to a data service. The data service may be operated by one or more insurance companies, by a third party, or by a government agency. The data service may optionally include data provided by local driver's licensing authorities, against which the data service validates the driver's license as well as his insurance.

Vehicles enabled for the system are fitted with a mobile device capable of reading the credential, which may take various forms, including an electronically read card or a PIN that is entered verbally or otherwise. The mobile device submits the credential to the data service for verification via a wireless network, and the data service responds via the wireless network with the vehicle's current insurance status.

It is an object of the invention to reduce the incidence of vehicles operating without required insurance by providing a system for electronically and wirelessly verifying a vehicle's insurance coverage combined with an ignition interlock to selectively allow or disallow operation of the vehicle based on the presence or absence of required insurance.

It is an object of the invention to provide drivers whose insurance has lapsed an opportunity to correct the problem prior to committing the crime of driving without insurance.

It is an object of the invention to provide a system for verifying required insurance on operating vehicles that enforces itself without having to use scarce law enforcement resources.

It is an object of the invention to deter theft of motor vehicles by making it difficult for a thief or unauthorized driver to obtain the credential required to operate the vehicle.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification.

They illustrate several exemplary embodiments of the invention and, together with the description, serve to explain the principles of the invention.

FIG. 1 shows a functional diagram of the system disclosed herein.

FIG. 2 shows a vehicle dashboard with a card reader-type mobile device mounted.

FIG. 3 shows a vehicle dashboard with a voice activated-type mobile device mounted.

FIG. 4 shows a flow chart of the method disclosed herein.

### DETAILED DESCRIPTION OF THE INVENTION

Referring now to the invention in more detail, disclosed below is a system and a method for preventing the operation of a motor vehicle without required insurance.

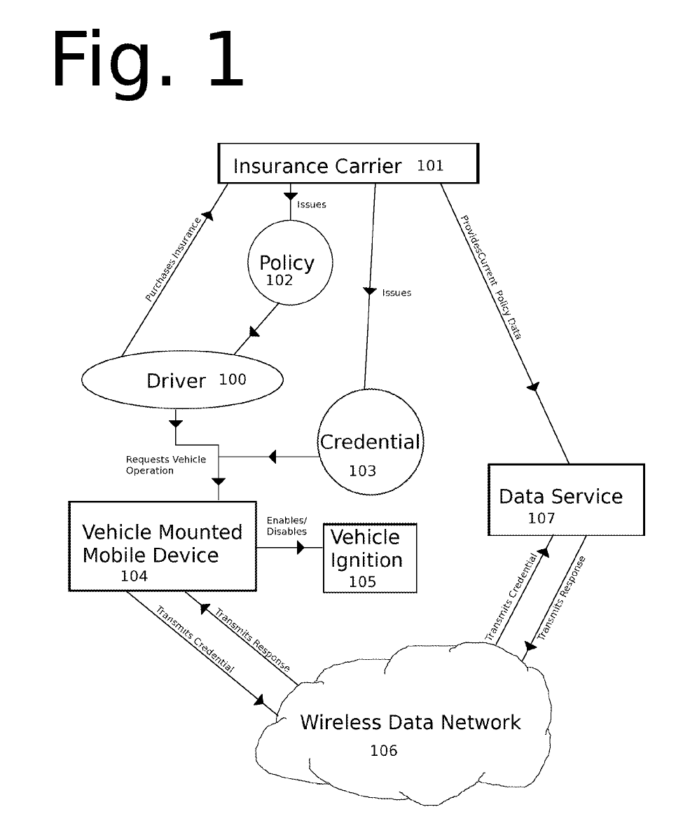

FIG. 1 shows a functional diagram of the basic components of a first exemplary embodiment of the system. In the system, a driver 100, having purchased liability insurance for a vehicle from an insurance carrier 101, receives from an insurance carrier a policy 102 and a credential 103. The system may be used with only a single participating insurance carrier 101, however any number of carriers may participate, and indeed the system is most effective when all or most insurance carriers participate. The policy 103, like all insurance policies, is a contract between the driver 100 and insurance carrier 101, and therefore it has no physical existence. The credential 103, however, is a collection of data that uniquely represents the relationship among the driver 100, insurance carrier 101, and the policy 102. Additionally, the credential 103 may further represent the driver's state-issued driver's license, identified by a license number, or other identifying information for the driver or vehicle.

Referring still to the system of FIG. 1, the system includes a vehicle mounted mobile device 104. The device 104 comprises an electronics casing containing an externally mounted screen, externally mounted input device, and internally mounted electronic components. The internally mounted electronic components comprise a microprocessor, a computer memory, a vehicle ignition controller, a wireless transmitter, and a wireless receiver. The described components, all well known in the prior art, are in electronic communication with each other, for example, by being mounted onto a printed circuit board with the appropriate connections.

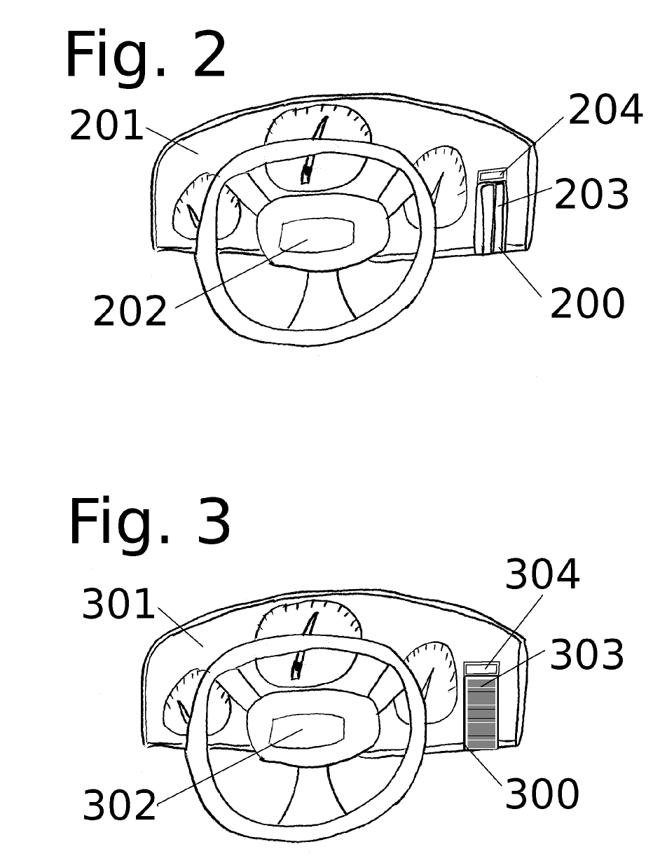

The particular input provided for the mobile device 104 depends on the form in which the credential 103 is issued. For example, FIG. 2 shows a second exemplary embodiment of the invention in which the mobile device 200 is mounted on the dashboard 201 of a vehicle near the vehicle's steering wheel 202. The device 200 features an externally mounted card reader 203 for a magnetic strip card. This card is provided by the insurance carrier 101 to store the credential 103. The second embodiment features a display screen 204 used for presenting the driver with the results of the insurance verification. FIG. 3 shows a third exemplary embodiment featuring again a mobile device 300 mounted on a vehicle dashboard 301 near the steering wheel 302, however the device of the third embodiment features a microphone 303 by which the device may receive a verbally presented PIN. The third embodiment features a display screen 304 used for presenting the driver with the results of the insurance verification. Optionally, any embodiment may further feature an electronic audio subsystem connected to one or more attached speakers or to the vehicle sound system; the audio subsystem would allow the results of the insurance verification to be presented to the driver audibly. The forms of the credential 103 and the input to the mobile device 104 may generally be varied, but must be compatible with one another

Referring still to the system of FIG. 1, the mobile device 104 is connected through its vehicle ignition controller to the vehicle ignition 105 to form an ignition interlock. The prior art discloses many means of selectively enabling a vehicle ignition or of otherwise selectively preventing a vehicle from operating, and any may be employed to achieve the purposes of the present invention.

Referring still to the system of FIG. 1, the mobile device 104 has the capability to communicate with a data network 106 through its wireless transmitter and wireless receiver. Any wireless data exchange technology, such as satellite links and mobile phone networks, may be used for this purpose. The wireless data network is further connected to a data service such that the credential 103 may be sent from the mobile device 104 to the data service 107 via the wireless data network 106, and such that the data service 107 may send a response to the mobile device 104 via the wireless data network 106. The connection between the wireless data network 106 and the data service 107 may be specially designed or may use an existing network such as the Internet. Many suitable data connection means are known in the prior art, and any may be used.

Referring still to the system of FIG. 1, the data service 107 may be provided independently, by one or more insurance carriers, or by an agency of government. The functions of the data service 107 are to be performed by software running on general purpose computers. Such software is well known in the prior art. The data service 107 receives regularly updated data on current insurance policies and credentials from the insurance carrier 101, and thus is kept up to date. As an optional feature, the data service may also validate the driver's license status or other relevant information that could be made a condition for driving.

Referring still to the system of FIG. 1, the mobile device 104 includes a software program, stored persistently in computer memory or on a data storage medium, capable of (i) accepting the credential 103 through the supplied input means, for example, voice recognition software may be included to capture a verbally spoken PIN detected via the provided microphone; (ii) transmitting the credential 103 to the data service 107 via its attached wireless transmitter and the wireless data network 106; (iii) receiving a verification signal from the data service 107 via the wireless data network 106; (iv) displaying a human readable message indicating whether insurance was verified as present or not on the mobile device's 104 attached screen 204 or 304 (optionally, an audio message may be played back using the optional audio subsystem described above); and (vi) selectively enabling or disabling the vehicle ignition 105 based on the response provided by the data service 107.

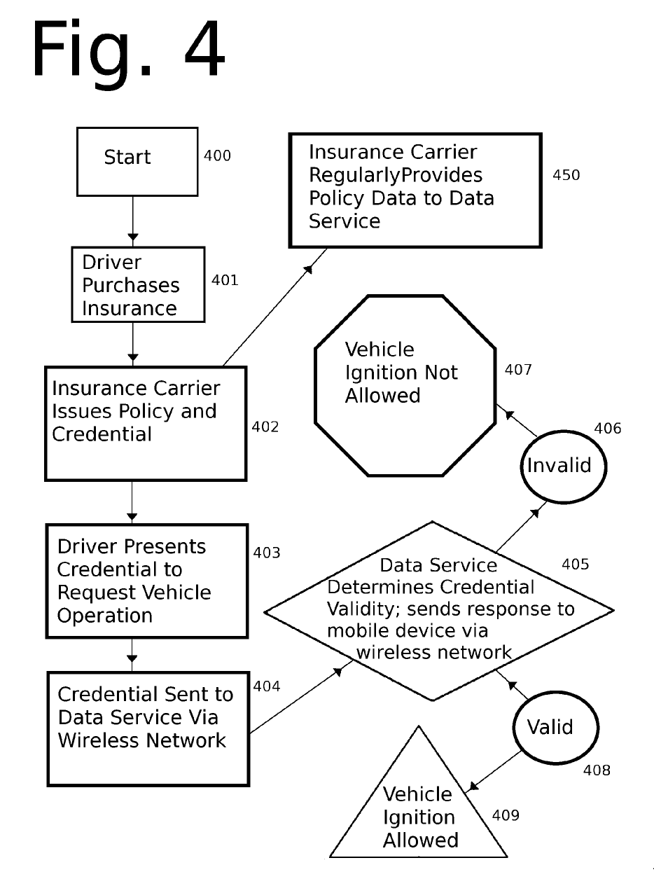

Referring now to the method of FIG. 4, the invention further comprises a method of using the above-described system to prevent a motor vehicle from operating without required insurance. In the method 400, a driver purchases insurance 401, whereupon the insurance carrier issues an insurance policy and a credential representing the relationship between the driver, policy, vehicle and other information 402. Insurance may be purchased and a policy issued by any means; many means of insurance sales and policy issuance are known in the prior art. Similarly, the policy credential may be issued in any of the many known forms available for electronically verifiable credentials. The insurance carrier takes the policy and credential information and provides it, on an ongoing basis, to the data service 450. If state-issued driver's licenses are to be validated, then the local licensing authority provides data pertaining to driver's license validity to the data service 450 in a similar manner.

Referring still to the method of FIG. 4, whenever the driver wishes to operate the insured vehicle, he presents the credential to the vehicle-mounted mobile device 403, using the appropriate means for the form of the credential that was issued. For example, if a voice-recognition system is employed to recognize a spoken PIN, the driver says his PIN aloud to present it to the mobile device. The mobile device then sends the credential to the data service via the mobile network 404. The data service then determines the validity of the credential 405, based on the data provided by the insurance carrier, and sends the response back to the mobile device via the wireless data network.

Referring still to the method of FIG. 4, the mobile device receives a response from the data service and, if the response indicates a valid credential 408, then the mobile device enables the ignition of the vehicle 409 or otherwise allows it to be operated. If, on the other hand, the response indicates an invalid credential, then the mobile device does not enable the vehicle ignition or otherwise disallows the vehicle to be operated. Attendant to allowing or disallowing the vehicle to be operated, the mobile device may notify the driver that his insurance validated successfully or unsuccessfully, for example by displaying a message on the attached display screen.

By implementing the above-described method and system, drivers whose insurance has lapsed will be prevented from starting their vehicles. Additionally, would-be drivers who have never purchased an insurance policy or are attempting to operate the vehicle without authorization are prevented from driving because they do not have any credential to present to the system for validation, and therefore cannot operate the vehicle. In this way, uninsured drivers and vehicles are kept from the road, and the incidence of accidents for which no insurance coverage for the liable party exists is diminished.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A system for preventing a motor vehicle from being operated without required insurance comprising:
at least one insurance carrier;
a driver;
said driver having purchased insurance from said insurance carrier;
an insurance policy;
said policy being issued to said driver by said insurance carrier to cover a vehicle;
a credential;
said credential being issued to said driver by said insurance carrier;
a mobile electronic device;
said mobile electronic device being mounted in the cabin of said vehicle;
a wireless data network;
a data service;
said data service receiving regular updates of policy and credential data from said one or more insurance carriers;
said mobile device and said data service being in electronic wireless communication with each other via said wireless data network;
said mobile device being capable of accepting as input said credential from said driver;
said mobile device being capable of transmitting, and said data service being capable of receiving said credential;
said data service being capable of determining, based on said credential, whether said insurance policy is active;
said data service being capable of transmitting, and said mobile device being capable of receiving said determination as a response;
said mobile device being capable of selectively allowing or disallowing said vehicle to be operated, based on the content of said response from said data service,
whereby said vehicle is prevented from being operated without required insurance.

2. The system of claim 1 wherein said credential takes the form of a Personal Identification Number (PIN).

3. The system of claim 2 wherein said mobile device includes a microphone and the software capability to recognize a spoken PIN.

4. The system of claim 1 wherein said credential takes the form of a card containing said credential as electronically stored data.

5. The system of claim 4 wherein said mobile device includes a reader for said card holding said credential.

6. The system of claim 1 wherein said data service includes the capability to determine the validity of said driver's state-issued license.

7. The system of claim 1 wherein said mobile device selectively allows or disallows said vehicle to operate through an ignition interlock.

8. The system of claim 1 wherein:
said credential takes the form of a PIN;
said mobile device includes a microphone and the software capability to recognize a spoken PIN;
said data service includes the capability to determine the validity of said driver's state-issued license;
and said mobile device selectively allows or disallows said vehicle to operate through an ignition interlock.

9. A method for preventing a motor vehicle from being operated without required insurance comprising:
a driver purchasing insurance from an insurance carrier to cover a vehicle,
said insurance carrier issuing an insurance policy and a credential to said driver,
said insurance carrier regularly sending updated policy and credential data to a data service,
said driver requesting operation of said vehicle by presenting said credential to a mobile device,
said mobile device transmitting said credential to said data service via a wireless data network,
said data service determining the current validity of said insurance policy identified by said credential,
said data service transmitting a response containing the current validity of said insurance policy to said mobile device via said wireless data network,
and said mobile device allowing said vehicle to be operated only if said response indicates that said insurance policy is active,
whereby said vehicle is prevented from being operated without required insurance.

10. The method of claim 9 wherein the step of said driver presenting said credential to a mobile device comprises said driver speaking a sequence of numbers that make up a PIN.

11. The method of claim 10 wherein said mobile device accepts said credential by presenting an audio signal of the voice of said driver to an electronic voice recognition means.

12. The method of claim 9 wherein the step of said driver presenting said credential to a mobile device comprises said driver inserting a card containing holding said credential as electronically stored data into a reader for said card electronically attached to said mobile device.

13. The method of claim 9 further comprising a step in which said data service validates said driver's state-issued driver's license against data provided by an applicable licensing authority, and in which said data service includes the result of the validation in its response, and in which said mobile device will decline to allow said vehicle to be operated unless the result of the validation indicates that said driver's state-issued license is valid.

14. The method of claim 9 wherein:
the step of said driver presenting said credential to a mobile device comprises said driver speaking a sequence of numbers that make up a PIN, and wherein said mobile device accepts said credential by presenting an audio signal of the voice of said driver to an electronic voice recognition means,
and further comprising a step in which said data service validates said driver's state-issued driver's license against data provided by an applicable licensing authority, and in which said data service includes the result of the validation in its response, and in which said mobile device will decline to allow said vehicle to be operated unless the result of the validation indicates that said driver's state-issued license is valid.
